(19) United States
(12) Patent Application Publication
(10) Pub. No.: US 2009/0055737 A1
(43) Pub. Date: Feb. 26, 2009

(54) Contextual Collaborative Electronic Annotations

(76) Inventors: Andreas Borchardt, Eppelheim (DE); Scott Cairncross, Chicago, IL (US); Jan Dostert, Nussloch (DE); Li Zhiyong, Shanghai (CN); Michel Martin, Laval (CA); Sandra Nieves, Karlsruhe (DE); Tarun Telang, Bhilai (IN); Jannis Rondorf, Mannheim (DE)

Correspondence Address: MINTZ, LEVIN, COHN, FERRIS, GLOVSKY & POPEO, P.C., ONE FINANCIAL CENTER, BOSTON, MA, 02111, US

(21) Appl. No.: 11/843,491

(22) Filed: Aug. 22, 2007

(51) Int. Cl. G06F 3/048

(52) U.S. Cl. 715/708; 715/705

(57) ABSTRACT

An application having an associated and a graphical user interface is initiated. Thereafter, the widget determines a first state of the application. Once the first state of the application is determined, the widget calls at least one remote repository to retrieve one or more electronic annotations associated with the first state of the application. These electronic annotations are then displayed in connection with the graphical user interface of the application.

### TECHNICAL FIELD

The subject matter described herein relates to contextual electronic annotation tools in a collaborative environment such as virtual sticky notes.

### BACKGROUND

In collaborative environments in which multiple users are accessing the same applications and/or electronic documents, there are few available mechanisms by which the various users can share contextually sensitive information regarding the application and/or electronic documents. The software program Post-It® Digital Notes, sold by 3M, allows a user to create virtual sticky notes. With such an arrangement, the virtual sticky notes are personal to a particular user on a particular computer. Moreover, such sticky notes are only associated with pre-designated electronic message boards or the desktop of a computer and are not available for use with a variety of applications and, or electronic documents.

### SUMMARY

An application that has an associated widget and a graphical user interface is initiated. Thereafter, the widget determines a first state of the application. Once the first state of the application is determined, the widget calls (by, for example, a web service, etc.) a remote repository to retrieve one or more electronic annotations (e.g., virtual sticky note, etc.) associated with the first state of the application. These electronic annotations are then displayed in connection (e.g., adjacent, overlaid, etc.) with the graphical user interface of the application.

The first state of the application can be based on a context ID obtained from an operating system on which the application is running. The context ID can in turn be mapped to electronic annotations stored in the remote repository.

When the state of the application changes from the first state to a second state, the displayed retrieved one or more electronic annotations can be removed from over the graphical user interface of the application. In some variations, a user can modify the displayed electronic annotations which results in such modifications being stored in the remote repository. Moreover, in some implementations, multiple repositories may be provided such that different systems have different associated repositories.

In an interrelated aspect, a first state of an application is initiated, the application having an associated and a graphical user interface. Thereafter, one or more electronic annotations associated with the first state of the application are identified, so that it can be determined whether a user associated with the application is authorized to access the one or more identified electronic annotations. Based on this determination, a remote repository is called to retrieve the identified one or more electronic annotations associated with the first state of the application that the user is authorized to access. These retrieved electronic annotations can be displayed in connection with the graphical user interface of the application.

In a further interrelated aspect, a first state of an application is initiated, the application having an associated and a graphical user interface. User-generated input specifying an electronic annotation is received, which results, in the widget initiating storage of data characterizing the electronic annotation in a remote repository to enable presentation of the electronic annotation over the graphical user Interface when the application subsequently enters the first state when accessed by an authorized user.

Articles are also described that comprise a machine-readable medium embodying instructions that when performed by one or more machines result in operations described herein. Similarly, computer systems are also described that may include a processor and a memory coupled to the processor. The memory may encode one or more programs that cause the processor to perform one or more of the operations described herein.

The subject matter described herein provides many advantages. For example, the current techniques allow for a user to store and access private information associated particular applications and application states. Moreover, the current techniques can be used to selectively provide such private information to other users in a collaborative and contextual manner.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating the display of an electronic annotation based on a context of all application;

FIG. 2 is a diagram illustrating the generation and access of electronic annotations by two collaborating users;

FIG. 3 is a diagram illustrating the display of a sticky note obtained from a repository when an application is initiated;

FIG. 4 is a diagram illustrating a user generating a sticky note which results in the sticky note being stored in a repository;

FIG. 5 is a diagram illustrating a user switching from a first application to a second application which results in sticky notes displayed in connection with the first application being withdrawn from display; and

FIG. 6 is a diagram illustrating the deletion of a sticky note by a user and a corresponding update of a repository.

Like reference symbols in the various drawings indicate like elements.

### DETAILED DESCRIPTION

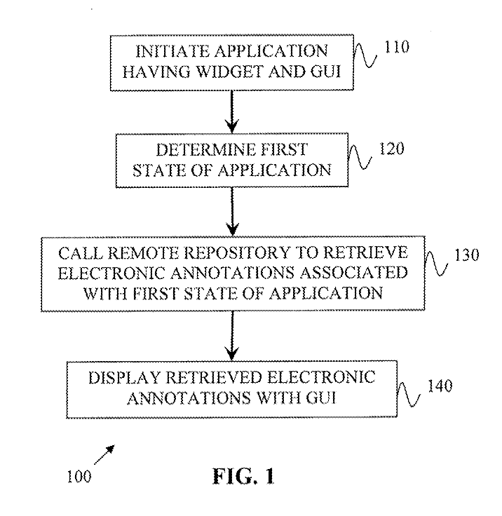

FIG. 1 is a process flow diagram illustrating a method 100 in which, at 110, a first state of an application that has an associated and a graphical user interface is initiated. Thereafter, at 120, the widget determines a first state of the application. Once the first state of the application is determined, at 130, the widget calls over the Internet (by, for example, a web service, etc.), a remote repository to retrieve one or more electronic annotations (e.g., virtual sticky note, etc.) associated with the first state of the application. These electronic annotations are then displayed, at 140, in connection (e.g., adjacent, overlaid, etc.) with the graphical user interface of the application.

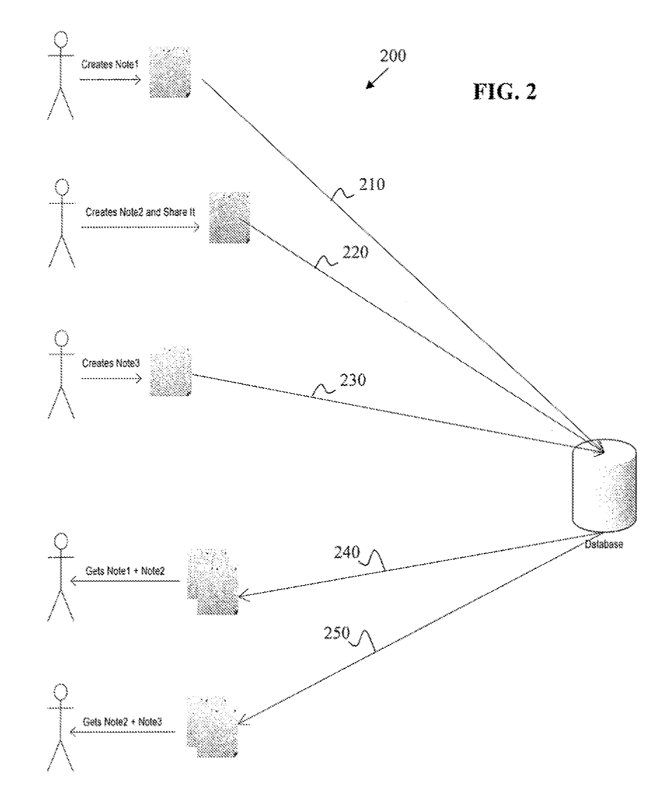

FIG. 2 is a diagram 200 in which User A, at 210, when accessing a software application creates a sticky note 1 for himself which is stored in a database. Additionally, User A, at 220, creates a sticky note 2 and makes it available to User B. User B, at 230, when accessing the application creates a sticky note 3 for himself. When User A subsequently accesses the application, at 240, User A is presented sticky notes 1 and 2, and when User B subsequently accesses the application, at 250, User B is presented sticky notes 2 and 3. While FIG. 2 illustrates an arrangement including a database, it will be appreciated that the database may be distributed and/or include an intermediary such as a load balancer or dispatcher disposed between the database and the users.

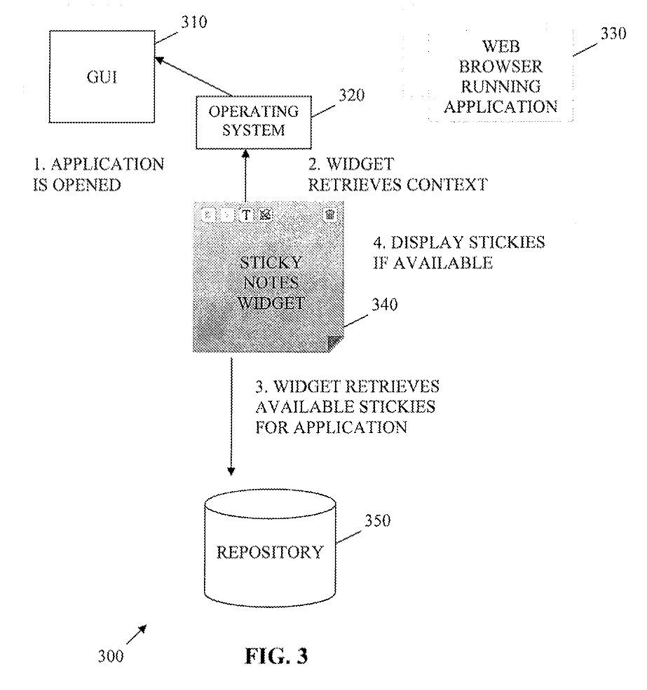

FIG. 3 is a diagram 300 in which an application graphical user interface 310 running on an operating system 320 includes a sticky note widget 340 (e.g., Yahoo! Widget, SAP Widget, etc.) associated therewith (i.e., the sticky note widget is a standalone component running beside a corresponding application and communicating with the operating system). The sticky note widget 340 can be a portable chunk of code that is installed and executed within the GUI 310 without requiring additional compilation. In some variations, the sticky note widget 340 is executed within an HTML-based web page within a web browser running the application 330. While widget 310 is referred to a sticky note widget because it can generate the graphical form of a conventional sticky note, it will be appreciated that the widget 340 may generate any form of electronic annotation to overlay on or otherwise be presented with the GUI 310 or the web browser 330. (Other terms used to describe the widget 340 include gadget, badge, module, capsule, snippet, mini and flake. The widget 340 can use, for example, Adobe Flash or JavaScript programming languages.

In operation, when the application having the GUI 310 is opened, the widget 340 retrieves (using, for example, web service calls, etc.) sticky notes available for the application from a repository 350 (e.g., ABAP report+database table, etc.). Any retrieved sticky notes are then displaced, which may include for example, overlay on the GUI 310 or the web browser 330. In some variations, the state of the application can be determined by the widget 340 in order to retrieve only those sticky notes in the repository 350 that are associated with the particular state of the application (e.g., e-mail inbox, calendar, etc.). The current techniques are applicable to basic ABAP (SAP GUI)/Java (Web Browser) functionality as well as other types of applications running on the desktop of an graphical operation system like Microsoft Windows XP/Vista or an any Linux desktop. Application state in the form of an application context ID can, in some implementations, remain static over different operating systems.

The widget 340, which is displaying the sticky notes, can retrieve the application context ID of the currently focused and chosen application window (i.e., application state) from the operating system 320. The widget 340 can, in some variations, catch an event when the focused application window is changed or checks in a defined period of time (e.g. 2 seconds) the operating system 340 for the currently focused application window.

In order to be able to have a contextual relationship between, for example, a GUI application 310 (e.g., SAP GUI application, etc.) and a web browser-based application 330 (e.g., SAP NetWeaver Portal application, etc.), the corresponding application context IDs (e.g. by a central sticky notes administration application) can be mapped to each other. With this, all notes created in the application context ID of the GUI application 310 are automatically mapped and displayed when running the related web browser-based application 330.

Moreover, the widget 340 may additionally determine if a user of the application is authorized to access certain sticky notes in the repository 350 and only cause those sticky notes for which the user has permission to access to be displayed.

The widget 340 acts to generate an electronic annotation, in one example, a sticky note which can be customized by a user. For example, the content (e.g., text, graphics, etc.), color, text size, note size, position, and the like can be modified by a user as he or she sees fit.

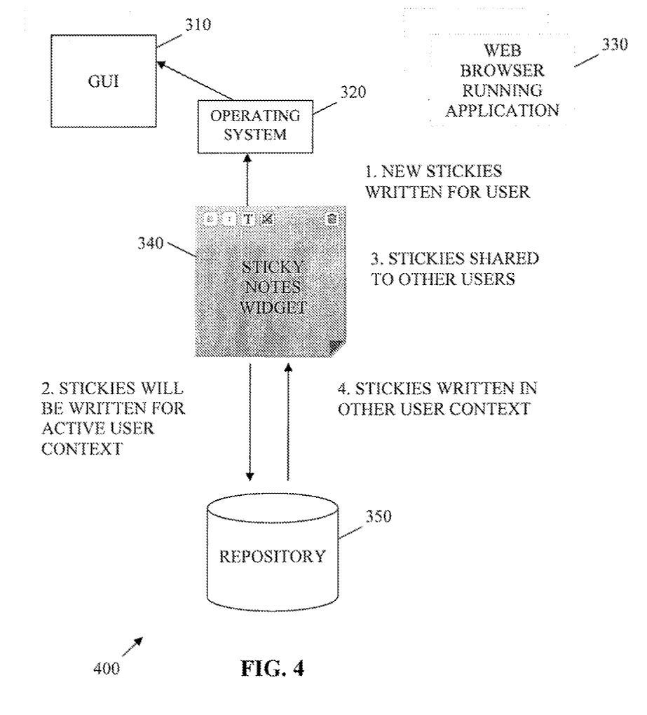

FIG. 4 is a diagram 400 which illustrates an arrangement in which a user of the GUI 310 causes a new sticky note to be generated by activating an element in the GUI 310 which initiates the generation of the sticky note. In this case, the user decides to make the sticky note available to other users, and when the sticky note is finalized, the widget 340 causes the sticky note to be stored in the repository 350 along with an indication of the active user context for such sticky note (e.g., application state, authorized users, etc.). This sticky note may be retrieved from the repository 350 by the widget 340 when subsequent users access the application at the same active user context. In some implementations, a sticky note block widget may also be running alongside widget 340 and in communication with widget 340 to allow for the creation of a new electronic annotations. In such a variation, generation of the sticky note might be initiated, for example, by activation of the second widget or by activation of a GUI element on an existing sticky note.

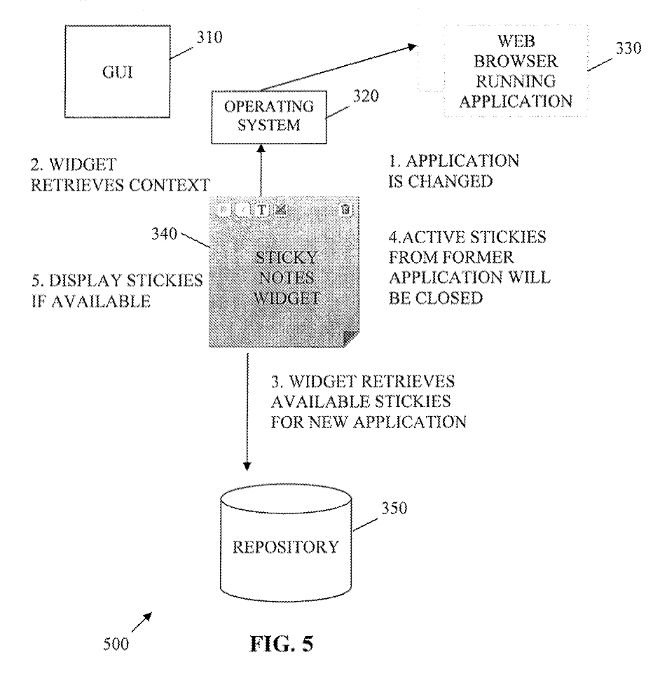

FIG. 5 is a diagram 500 illustrating an arrangement in which a user of the GUI 310 switches to a web browser-based application 330. As a result of the change of the application, the widget 340 retrieves the context of the application, retrieves available sticky notes for the web browser-based application 330 from the repository 350, closes the active sticky notes from the previous application, and causes the retrieved sticky notes to be displayed in the web browser-based application 330.

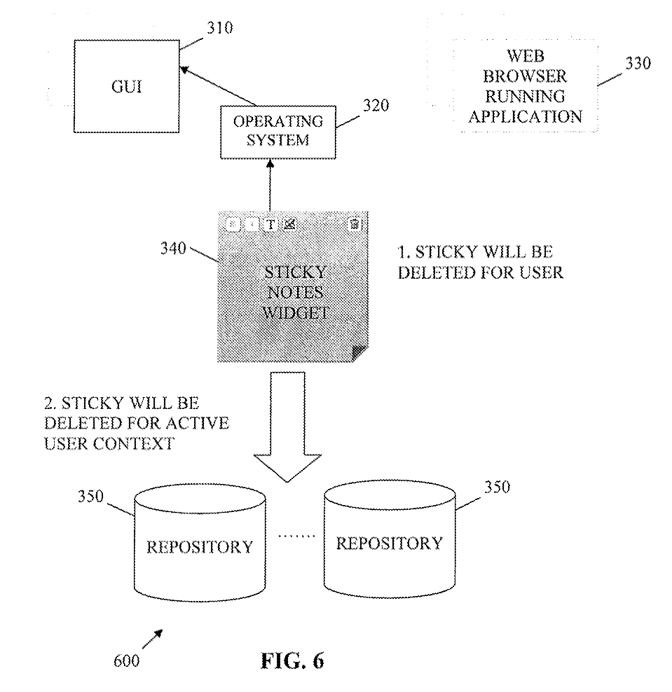

FIG. 6 is a diagram 600 illustrating an arrangement in there are multiple repositories 350 associated with the widget 350. The multiple repositories 350 may each be associated, for example, with different systems or applications such that all sticky notes for the corresponding system or application are stored within such repository 350. In this example, a user of the GUI 310 initiates the deletion of a displayed sticky note displayed via the widget 340. Coincidental with the removal of the rendering of the sticky note, the widget 340 causes the sticky note to be deleted in the corresponding repository 350 for the particular active user context.

As can be appreciated, there are numerous scenarios in which a centralized electronic annotation system can be utilized. In a first example, business user Alice is a sales analyst working on reports in her SAP NetWeaver Portal. She uses the sticky notes in this application in order to remind her of tasks she has to do. She realizes that there is a mistake in one of the address fields of a company. Even though this is not a critical issue, she has to get it corrected. She simply adds a sticky note to the report administration user, that he should have a look on this issue. In the absence of a collaborative sticky note repository, Alice would have had to open a ticket (with a lot of required follow up).

Joe is a sales data administrator working in his administration cockpit in a SAP GUI screen. Joe uses the sticky notes in order to remind him of personal tasks he has to do the following days. Joe sees the sticky note from Alice that there is a mistake in the address field of a company, so he corrects the mistake. He changes Alice former sticky note, adds “done”, and shares this modified sticky note with Alice again. Joe deletes this sticky note for himself

After Joe has modified the sticky note, Alice is in her report and sees from the modified sticky note that the problem is solved. She is pleased about it and deletes the sticky note.

In a second example, Joe wants to do his weekly time recording in a time recording transaction. Joe has a lot of different accounting numbers to use so he stores them all on sticky notes in the time recording transaction application so that they are connected to the application context.

Various implementations of the subject matter described herein may be realized in digital electronic circuitry, integrated circuitry, specially designed ASICs (application specific integrated circuits), computer hardware, firmware, software and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”) a wide area network (“WAN”), and the Internet.

The computing system may include clients and servers. A client and server and generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures are described herein do not require the particular order shown, or sequential order, to achieve desirable results. Other embodiments may be within the scope of the following claims.

What is claimed is:

1. An article comprising a tangible machine-readable medium embodying instructions that when performed by one or more machines result in operations comprising:
initiating a first state of an application, the application having an associated and a graphical user interface;
determining, by the widget, the first state of the application;
calling, by the widget, a remote repository to retrieve one or more electronic annotations associated with the first state of the application; and
displaying the retrieved one or more electronic annotations in connection with the graphical user interface of the application.

2. An article as in claim 1, wherein the article further embodies instructions that when performed by one or more machines result in operations comprising:
retrieving a context ID for the first state of the application; and
mapping the retrieved context ID to the electronic annotations stored in the remote repository.

3. An article as in claim 2, wherein the context ID is retrieved by an operating system on which the application runs.

4. An article as in claim 1, wherein the electronic annotation is a virtual sticky note.

5. An article as in claim 1, wherein the displayed retrieved one or more electronic annotations are overlaid on top of the graphical user interface.

6. An article as in claim 1, wherein the article further embodies instructions that when performed by one or more machines result in operations comprising:
removing the displayed retrieved one or more electronic annotations from over the graphical user interface of the application when the application transitions from the first state to a second state.

7. An article as in claim 1, wherein the calling comprises initiating a web service.

8. An article as in claim 1, wherein the article further embodies instructions that when performed by one or more machines result in operations comprising,
receiving user-generated input modifying, the displayed retrieved one or more electronic annotations; and
storing data characterizing the modified displayed retrieved one or more electronic annotations in the repository.

9. An article comprising a tangible machine-readable medium embodying instructions that when performed by one or more machines result in operations comprising:
initiating a first state of an application, the application having an associated and a graphical user interface;
determining the first state of the application;
identifying one or more electronic annotations associated with the first state of the application;
determining whether a user associated with the application is authorized to access the one or more identified electronic annotations;
calling a remote repository to retrieve identified one or more electronic annotations associated with the first state of the application that the user is authorized to access; and
displaying the retrieved one or more electronic annotations adjacent to or over the graphical user interface of the application.

10. An article as in claim 9, wherein the article further embodies instructions that when performed by one or more machines result in operations comprising:
retrieving a context ID for the first state of the application; and
mapping the retrieved context ID to the electronic annotations stored in the remote repository.

11. An article as in claim 9, wherein the context ID is retrieved by an operating system on which the application runs.

12. An article as in claim 9, wherein the displayed retrieved one or more electronic annotations are overlaid on top of the graphical user interface.

13. An article as in claim 9, wherein the article further embodies instructions that when performed by one or more machines result in operations comprising:
removing the displayed retrieved one or more electronic annotations from over the graphical user interface of the application when the application transitions from the first state to a second state.

14. An article as in claim 9, wherein the calling comprises initiating a web service.

15. An article as in claim 9, wherein the article further embodies instructions that when performed by one or more machines result in operations comprising:
receiving user-generated input modifying the displayed retrieved one or more electronic annotations; and
storing data characterizing the modified displayed retrieved one or more electronic annotations in the repository.

16. An article comprising a tangible machine-readable medium embodying instructions that when performed by one or more machines result in operations comprising:
initiating a first state of an application, the application having an associated and a graphical user interface;
receiving user-generated input specifying an electronic annotation; and
initiating, by the widget, storage of data characterizing the electronic annotation in a remote repository to enable presentation of the electronic annotation over the graphical user interface when the application subsequently enters the first state when accessed by an authorized user.

17. An article as in claim 16, wherein the article further embodies instructions that when performed by one or more machines result in operations comprising:
displaying the electronic annotation when an authorized user accesses the application when the application is in the first state.

18. An article as in claim 17, wherein the article further embodies instructions that when performed by one or more machines result in operations comprising:
removing the displayed electronic annotation when the application changes from the first state to a second state.

19. An article as in claim 16, wherein the displayed electronic annotation is overlaid on top of the graphical user interface.

20. An article as in claim 16, wherein the displayed electronic annotation is displayed adjacent to the graphical user interface.
